(19) United States
(12) Patent Application Publication
(10) Pub. No.: US 2023/0155468 A1
(43) Pub. Date: May 18, 2023

(54) ELECTRIC MOTOR, DRIVE ASSEMBLY AND ELECTROMECHANICAL BRAKE DEVICE

(71) Applicant: ZF Active Safety GmbH, Koblenz (DE)

(72) Inventors: Hans Martin Giese, Polch (DE); Hans-Jürgen Griebel, Kettig (DE); Linus Pohle, Koblenz (DE); Steve Scherer, Bilkheim (DE); Frank Gummersbach, Remagen (DE)

(21) Appl. No.: 17/985,384

(22) Filed: Nov. 11, 2022

(30) Foreign Application Priority Data
Nov. 18, 2021 (DE) 102021130180.7

(51) Int. Cl. H02K 21/30

(52) U.S. Cl. CPC H02K 21/30; F16D 2121/24

(57) ABSTRACT

An electric motor, in particular for an electromechanical brake device of a vehicle, includes a stator and a multi-pole rotor with an odd number of rotor poles. Recesses are defined in the central region of the rotor poles, drive assembly, and electromechanical brake device for a vehicle.

### CROSS-REFERENCE TO RELATED APPLICATION

This application claims priority to German Priority Application No. 102021130180.7, filed Nov. 18, 2021, the disclosure of which is incorporated herein by reference in its entirety.

### TECHNICAL FIELD

The disclosure relates to an electric motor for an electromechanical brake device of a vehicle. The disclosure moreover relates to a drive assembly, in particular an actuator, and to an electromechanical brake device for a vehicle.

### BACKGROUND

Vehicle brake systems often have electromechanical brake systems (EMB, EMB actuators, EPB, EPB actuators), electromechanical brake boosters (electronic brake boosters, EBB, EBB actuators) or integrated brake systems (IBC, IBC actuators). The energy or auxiliary energy is usually generated electrically in order to apply or boost braking force. Electric motors and actuators are often used here. For example, electromechanical brake systems are often used as electronic parking brakes (EPB) in which a brake lining is pressed against the brake disc by an actuator (EPB actuator) with an electric motor and an actuating member.

In the case of such actuators, such as EPB actuators, excitation occurs, in particular bending torques which excite vibration and have a negative effect on the actuator. The rotor poles can deform elastically under the magnetic forces which occur in the electric motor. In particular, electric motors with an odd number of grooves generate alternating magnetic forces in the air gap between the rotor and the stator which can excite the bending vibration, for example of the EPB actuator. This can cause undesired noises with a correspondingly rapid deformation or vibration.

### SUMMARY

An electric motor can be for an electromechanical brake device. The electromechanical brake device can be for a vehicle. The electromechanical brake device can be configured or specified for use in a vehicle. The vehicle can be a motor vehicle. The motor vehicle can be a car or lorry. The brake device can be a motor vehicle brake device. The brave device can be a brake system.

The electric motor can be a direct-current motor. The electric motor can be a brushless direct-current motor. For example, the electric motor can be a brushless direct-current motor (BLDC motor). The electric motor can be an electric synchronous machine such as a permanent magnet synchronous machine (PMSM). The electric motor can be a mechanically commutated or electronically commutated direct-current motor. The electric motor can be designed as an internal rotor.

The electric motor can have a stator. The stator can be designed as a permanent magnet stator. The stator can have at least one permanent magnet. The stator can have at least one, for example bipolar, permanent magnet ring. The stator can have at least two, for example, opposite, magnet poles. The stator can have a cylindrical design. The stator can be a stator well. The stator can have a, for example, cylindrical inner wall. The permanent magnet or the, for example, bipolar permanent magnet ring can be arranged on the inner wall of the stator. The permanent magnet or the permanent magnet ring can have a positive pole and a negative pole. The poles, for example the positive pole and the negative pole, of the permanent magnet or the permanent magnet ring can be arranged opposite each other, for example in the radial direction. The poles can have a curved design. The poles can be designed as curved poles. The poles can extend in a circumferential direction.

The electric motor can have a rotor. The rotor can be connected to a rotor shaft. The rotor can have a multi-pole design. The rotor can have rotor poles. The rotor can have an odd number of rotor poles. For example, the number of rotor poles can be 3, 5, 7 or more. The rotor can be arranged rotatably essentially inside the stator, for example inside the cylindrical inner wall of the stator and/or inside the stator well of the stator. The rotor can be arranged rotatably essentially inside the permanent magnet or the permanent magnet ring of the stator. A cylindrical air gap can be formed between the stator, for example between the inner wall of the stator, and the rotor. A cylindrical air gap can be formed between the permanent magnet or the permanent magnet ring of the stator and the rotor. The rotor can rotate about an axis of rotation, in particular inside the stator.

Unless otherwise stated or unless the context dictates otherwise, the specifications “axial”, “radial” and “circumferentially” relate to the direction of extent of the axis of rotation of the rotor. “Axial” then corresponds to a direction of extent of the axis of rotation. “Radial” is then a direction which is perpendicular to the direction of extent of the axis of rotation and intersects with the axis of rotation. “Circumferentially” then corresponds to a direction in an arc of a circle about the axis of rotation.

The rotor poles of the rotor can be designed so that they are essentially T-shaped and/or anchor-shaped. The rotor poles can have T side arms. The T side arms can have a curved design, for example circumferentially. The T side arms can extend circumferentially.

The rotor poles and/or their T side arms can be spaced apart from one another, in particular circumferentially. A groove can be formed between in each case two adjacent rotor poles or T side arms. For example, a groove can be formed circumferentially between in each case two adjacent rotor poles or T side arms. The grooves can be formed so that they are axially continuous and/or run axially coritinu-ously and/or extend in the axial direction. The rotor can have an odd number of grooves. For example, the number of grooves can be 3, 5, 7 or more. The number of grooves, such as the groove number, can correspond to the number of rotor poles, such as the rotor pole number.

The rotor poles can each have a core section situated radially on the inside. The core section can be a T stem. The T side arms can be arranged radially on the outside of the core section. Each rotor pole can have two side arms, such as side limbs. The rotor poles, for example their core sections, can be connected to each other radially on the inside. Each rotor pole or each core section can have a coil and/or coil windings. The coil can be an electric coil. The coil and/or coil windings can be arranged around the core section. The coil and/or coil windings can have electrically conductive wires and/or windings. The wires and/or windings can be wound around the core section. The coil and/or coil windings can be connectable and/or be connected to a supply source, such as a power source and/or voltage source, and/or to a control circuit.

The rotor and/or the rotor poles can have at least one lamination stack, such as a rotor lamination stack, consisting of layers of laminations or rotor laminations, and/or be produced therefrom. The laminations can be produced by a cutting method such as a water-jet cutting method or laser cutting method, and/or a stamping method. The laminations can be adhesively bonded and/or press-fitted and/or welded to one another, for example to form a lamination stack. The laminations can be coated with an insulator such as insulating material. The laminations can have a gap, such as an air gap, between them at least in some places. For example, the lamination can be an electrical lamination, steel, iron or an iron/silicon alloy.

The rotor can have recesses. Recesses can be provided in the central region of the rotor poles. The recesses can be arranged on the end sides of the rotor poles. At least one recess can be associated with each rotor pole. Each rotor pole can have at least one recess. Exactly and/or only one recess can be associated with each rotor pole. Each rotor pole can have exactly and/or only one recess. Each rotor pole can, for example, have exactly and/or only one recess in its central region. Each recess can be arranged, for example circumferentially, between the two edges of the respective core section of the rotor pole. Each recess can be arranged centrally relative to the respective core section of the rotor pole, for example circumferentially. The recesses and the grooves formed between adjacent rotor poles and/or T side arms can be arranged essentially opposite one another, for example diametrically, in the radial direction. Each recess can be associated with a groove situated radially, for example diametrically, opposite. Each recess can be arranged radially, for example diametrically, opposite a groove. The number of recesses, such as the recess number, can correspond to the number of rotor poles, such as the rotor pole number, and/or to the number of grooves, such as the groove number.

The recesses can be arranged radially on the outside. The recesses can be arranged radially on the outside of the core sections of the rotor poles. The recesses can extend and/or run radially inwards, starting from the outer circumference of the rotor poles. The recesses can extend at least in a direction, such as the radial direction, essentially in the direction of the magnetic field lines. The recesses can be formed so that they are axially continuous and/or run axially continuously and/or extend in the axial direction. The recesses can be open in the axial direction and/or be open radially to the outside. The recesses can be formed as grooves or slots. The recesses can be formed so that they are at least in some places essentially rectangular, triangular or curved, for example in cross-section. The recesses can be formed so that they are at least in some places U-shaped, V-shaped or A-shaped, for example in cross-section.

The recesses can be formed and/or arranged in such a way that the magnetic field, for example the flux and/or the field line pattern of the magnetic field, is influenced and/or modified. The recesses can be formed so as to act on the magnetic field, for example on the flux and/or the field line pattern of the magnetic field. The recesses can be formed so as to act on and influence the magnetic field, for example on the flux and/or the field line pattern of the magnetic field. The recesses can be formed so as to disrupt the homogeneity of the rotor poles.

A drive assembly can be for an electromechanical brake device. The drive assembly can be an actuator, such as an electromechanical actuator. The drive assembly can be a brake actuator. The actuator or brake actuator can be an actuator for a brake device, such as a parking brake device.

The drive assembly can comprise an electric motor. The electric motor can be designed as described above and/or below. The drive assembly can comprise an actuating device, such as an actuating member. The actuating device can be a mechanical actuating device. The actuating device can be designed to interact with the electric motor. The electric motor can be designed to actuate the actuating device. The actuating device can be designed to maintain a braking force acting on a brake disc of a wheel brake by the actuating device pressing a brake lining and/or friction lining against the brake disc.

The drive assembly can have a supply source. The supply source can be and/or have a voltage supply, such as a voltage source, and/or a power supply, such as a power source. The supply source can be the supply source of the brake device and/or the drive assembly and/or the electric motor of the drive assembly. The supply source can be connected, in particular electrically, to the electric motor.

The drive assembly can have a control circuit. The control circuit can be configured to control the electric motor in an open and/or closed loop. The control circuit can be connected, in particular electrically, to the supply source.

An electromechanical brake device can be for a vehicle. The electromechanical brake device can be configured and/or specified for use in a vehicle. The vehicle can be a motor vehicle. The motor vehicle can be a car or lorry. The electromechanical brake device can be a motor vehicle brake device. The brake device can be a brake system. The electromechanical brake device can be a parking brake device, for example an electric parking brake (EPB). The electromechanical brake device can be designed to provide a braking force permanently, in particular when the vehicle temporarily assumes a stationary state, for example a parked state or when driving on a hill.

The electromechanical brake device can comprise an electric motor. The electric motor can be designed as described above and/or below. The electromechanical brake device can comprise a drive assembly. The drive assembly can be designed as described above and/or below. The electromechanical brake device can be designed to press a brake lining against a brake disc by an electric motor and/or by the drive assembly.

The electromechanical brake device can be designed to hold and/or mechanically retain the drive assembly and/or a wheel brake piston in a position in which braking force is generated. The term “tyre” can be chosen above and/or below instead of the term “wheel”.

The electromechanical brake device can have a brake pedal. The drive assembly can be coupled actively, such as mechanically and/or electrically, to the brake pedal. The electromechanical brake device can have a corresponding brake shoe. The drive assembly can be designed to actuate the brake lining and/or friction lining or the brake shoe, for example by the electric motor and/or the actuating device, in such a way that a clamping force is exerted against the brake disc and in this way a parked state is effected. The brake disc can be connected non-rotatably to an axle of the vehicle and/or to a vehicle wheel. The brake shoe can press against the brake disc via at least one brake lining fastened thereto.

In other words, a rotor modification is proposed for the purpose of force symmetrization in electric motors, such as DC motors, with an odd groove number. The electric motor can be part of an EPB actuator. The magnetic force in the air gap can increase sharply when the front edge of a coil core or the flux conductor configured as a lamination stack enters the magnetic field of a magnet pole. At the edge of the lamination stack in the rotor and also of the magnets, the field lines not only run in a radial direction but also have tangential components. As the rotor continues to rotate, the magnetic force in the air gap between the magnet and the coil core continues to increase but the tangential force component decreases markedly because the field lines run largely parallel in a radial direction inside the magnet and also the central region of the T-shaped coil core on the rotor. By virtue of the modification of the lamination stack in the centre between the two edges of the coil core, in particular by the provision of recesses, the magnetic flux and hence also the local magnetic force density is reduced. The magnetic force in the air gap therefore initially decreases when the recesses enter the magnetic field. The magnetic flux is higher again on the rear side of the recesses or grooves. The magnetic force in the air gap therefore increases again after the recesses enter the magnetic field. In the correspondingly modified rotor with an odd groove number, grooves and recesses are situated diametrically opposite one another. When the front edge of the coil core or the lamination stack enters the magnetic field of a magnet, an increase in magnetic force in the opposite direction thus takes place at the recess on the opposite side with the smallest possible time delay such that the resulting total magnetic force and hence also the vibration-exciting bending torque on the actuator are reduced. The frequency with which the magnetic force peaks occur during a revolution is given in the case of the motor with 2 magnet poles and an odd groove number N by the product 2*N. With the proposed modification of the rotor with an odd groove number, when the edge of the coil core enters the magnetic field, a magnetic force in the opposite direction is generated at the opposite recess such that the resulting total force and hence also the vibration-exciting bending torque on the actuator are reduced. There is thus no need to increase the coil number.

The oscillating radial forces in the EPB actuator or electric motor can be minimized with the disclosure. Vibrations or vibration-exciting bending torques and noises can be minimized. Costs can be reduced.

### BRIEF DESCRIPTION OF DRAWINGS

Exemplary arrangements of the disclosure are described in detail below with reference to the drawings, in which, schematically and by way of example:

FIG. 1 shows a known electric motor with three different rotor positions;

FIG. 2 shows the magnetic field at a rotor pole of the electric motor according to FIG. 1;

FIG. 3 shows an electric motor according to a variant of the present disclosure with three different rotor positions;

FIG. 4 shows a rotor pole of the electric motor according to FIG. 3 with a variant of the recess and, schematically, the magnetic field which is formed; and

FIG. 5 shows a rotor pole of the electric motor according to FIG. 3 with a further variant of the recess and, schematically, the magnetic field which is formed.

### DETAILED DESCRIPTION

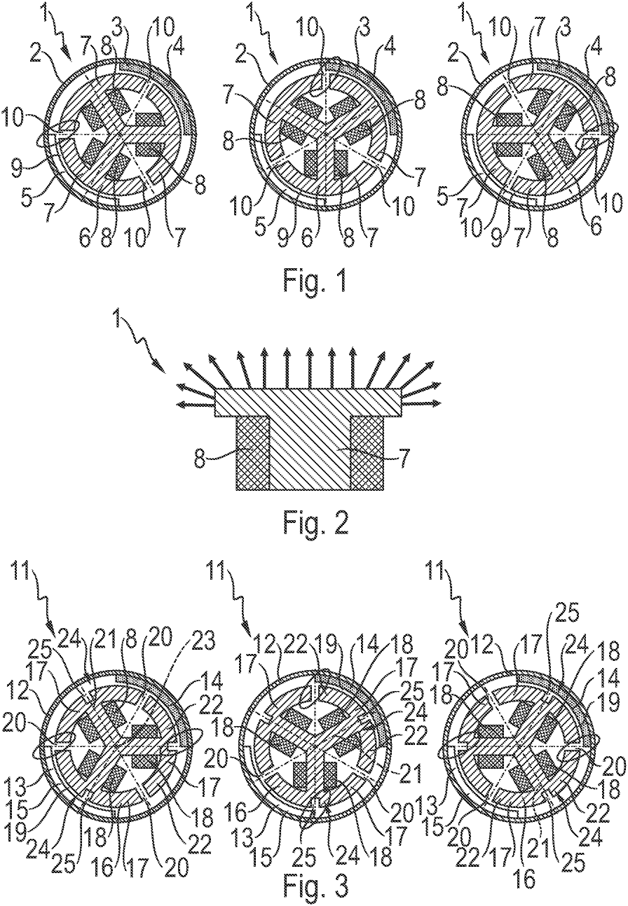

FIG. 1 shows schematically a known electric motor 1 with three different rotor positions in which in each case attraction and/or repulsion take place. The electric motor 1 has a permanently magnetic stator 2 with a permanent magnet ring 3 with a positive pole 4 and a negative pole 5.

The electric motor 1 moreover has a rotor 6 arranged rotatably inside the stator 2. The rotor 6 has three T-shaped rotor poles 7 with coils 8. An air gap 9 is formed between the rotor 6 and the stator 2. The rotor 6 moreover has an odd number of grooves 10, in this case three grooves 10, or of rotor poles 7, in this case three rotor poles 7, each with one coil 8.

The magnetic force in the air gap 9 can increase significantly when the front edge of the coil core of a rotor pole 7 enters the magnetic field of one of the magnet poles 4, 5. The magnetic force differs significantly at the opposite side of the rotor. As a result, a vibration-exciting bending torque is generated which makes the rotor vibrate and causes undesired noises.

FIG. 2 shows schematically the magnetic field which is formed at a rotor pole 7 of the electric motor 1 according to FIG. 1.

At the edge of the rotor pole 7 and also of the magnet 3, the field lines run not only in a radial direction but also have tangential components. As the rotor 6 continues to rotate, the magnetic force in the air gap 9 between the magnet 3 and the coil core continues to increase. However, the tangential force component decreases markedly because the field lines run largely parallel in a radial direction inside the magnet 3 and also the central region of the T-shaped rotor pole 7.

FIG. 3 shows an electric motor 11 according to a variant of the present disclosure with three different rotor positions, in which in each case the attraction and repulsion essentially cancel each other out and hence vibration-exciting bending torques are prevented or at least significantly reduced.

The electric motor 11 has a permanently magnetic stator 12 with a permanent magnet ring 13 with a positive pole 14 and a negative pole 15. The positive pole 14 and the negative pole 15 are arranged radially opposite each other.

The electric motor 11 moreover has a rotor 16 arranged rotatably about an axis of rotation 22 inside the stator 12. The rotor 16 has three T-shaped rotor poles 17 with coils 18. A cylindrical air gap 19 is formed between the rotor 16 and the stator 12. The rotor 16 moreover has an odd number of grooves 20, in this case three grooves 20, or rotor poles 17, in this case three rotor poles 17, each with one coil 18.

The rotor poles 17 each have a core section 21 situated radially on the inside and T side arms arranged radially on the inside, attached to the latter and curved circumferentially. The coils 18 have coil windings which are wound about the core sections 21. The rotor poles 17 or their T side arms 22 are spaced apart circumferentially, wherein the groove 20 is formed between in each case two adjacent rotor poles 17 or T side arms 22. The grooves 20 are formed so that they are axially continuous.

Recesses 25 are defined in the central region 24 of the rotor poles 17. Each recess 25 is arranged circumferentially between the two edges of the respective core section 21 of the rotor pole 17 and centrally with respect to the respective core section 21 of the rotor pole 17. The recesses are formed as axially continuous grooves and arranged radially on the outside of the core sections 21 of the rotor poles 17. Moreover, the recesses 25 extend radially inwards, starting from the outer circumference of the rotor poles 17, and are open radially to the outside in the axial direction.

Each recess 25 and a groove 20 formed between adjacent rotor poles 17 or T side arms 22 are arranged essentially opposite one another in the radial direction or diametrically opposite. The number of recesses 25 therefore corresponds to the number of rotor poles 17 and the number of grooves 20. In particular, there is an odd number, such as 3, 5 or more. In the present exemplary arrangement according to FIG. 3, three recesses 25, three rotor poles 17 and three grooves 20 are defined. Each rotor pole 17 thus has exactly and only one recess 25 in its central region.

The recesses 25 are formed and arranged in such a way that the magnetic field, in particular the flux and/or the field line pattern of the magnetic field, is influenced or modified. As a result, when they enter the magnetic field, a magnetic force in the opposite direction is generated at the opposite recess 25 such that the resulting total force and hence also the vibration-exciting bending torque is reduced.

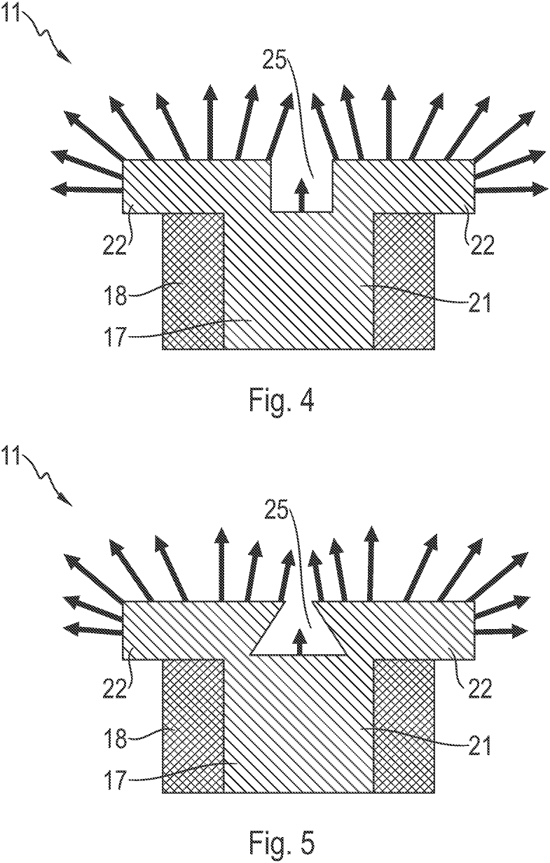

FIG. 4 shows schematically the magnetic field which is formed at a rotor pole 17 of the electric motor 11 according to FIG. 3 with a variant of the recess 25.

The recess 25 is here formed as a groove which is rectangular in cross-section.

By virtue of the recess 25, the magnetic flux and hence also the local magnetic force density can be modified, for example reduced. The magnetic force in the air gap can therefore initially decrease when the recess 25 enters the magnetic field. The magnetic flux can be higher again on the rear side of the recess 25. The magnetic force in the air gap 19 can therefore increase again after the recess 25 enters the magnetic field.

Otherwise, for further information reference should be made in particular to FIG. 3 and the associated description.

FIG. 5 shows schematically the magnetic field which is formed at a rotor pole 17 of the electric motor 11 according to FIG. 3 with a different variant of the recess 25.

The recess 25 is here formed with an essentially triangular cross-section.

Otherwise, for further information reference should be made in particular to FIGS. 3 and 4 and the associated description.

In particular, optional features of the disclosure are designated by “can”. Therefore, there are also developments and/or exemplary arrangements of the disclosure which additionally or alternatively have the respective feature or the respective features.

Isolated features can as required, also be singled out from combinations of features disclosed in this document and, by breaking a structural and/or functional link which may exist between the features, be used in combination with other features in order to define the subject-matter of a claim.

1. An electric motor comprising a stator and a multi-pole rotor with an odd number of rotor poles, wherein recesses are defined in the central region of the rotor poles.

2. The electric motor according to claim 1, wherein the recesses are formed and/or arranged in such a way that the magnetic field, is influenced and/or modified.

3. The electric motor according to claim 1 wherein the stator is designed as a permanently magnetic stator, and the stator has at least two opposite magnet poles.

4. The electric motor according to claim 1, wherein a cylindrical air gap is formed between the stator and the rotor.

5. The electric motor according to claim 1, wherein the rotor is arranged rotatably inside the stator.

6. The electric motor according to claim 1 wherein the rotor poles are designed so that they are T-shaped and/or anchor-shaped.

7. The electric motor according to claim 6, wherein the rotor poles have T side arms having a curved design.

8. The electric motor according to claim 1, wherein the rotor poles are spaced apart from one another circumferentially and an in particular axially continuous groove is formed between in each case two adjacent rotor poles.

9. The electric motor according to claim 1, wherein the rotor poles each have a core section situated radially on the inside with coil windings and/or a coil.

10. The electric motor according to claim 1, wherein the recesses are formed so that they are axially continuous.

11. The electric motor according to claim 1, wherein the recesses are formed as grooves or slots.

12. The electric motor according to claim 1, wherein the recesses are formed so that they are at least in some places essentially rectangular, triangular, or curved in cross-section.

13. The electric motor according to claim 1, wherein each recess is arranged between the two edges of the respective core section of the rotor pole.

14. The electric motor according to claim 1, wherein each recess is arranged centrally relative to the respective core section of the rotor pole.

15. The electric motor according to claim 1, wherein the recesses are arranged radially on the outside of the core sections of the rotor poles.

16. The electric motor according to claim 1, wherein the recesses extend radially inwards, starting from the outer circumference of the rotor poles.

17. The electric motor according to claim 1, wherein the recesses are open in the axial direction and/or open radially to the outside.

18. The electric motor according to claim 1, wherein the recesses and the grooves formed between adjacent rotor poles are arranged essentially opposite one another in the radial direction.

19. The electric motor according to claim 1, wherein the number of recesses corresponds to the number of rotor poles and/or each rotor pole. has in particular exactly and/or only one recess in its central region.

20. The electric motor according to claim 1, wherein the rotor and/or the rotor poles have at least one lamination stack consisting of layers of laminations or are produced therefrom.

21-26. (canceled)
